(19) United States
(12) Patent Application Publication
(10) Pub. No.: US 2008/0040100 A1
(43) Pub. Date: Feb. 14, 2008

(54) PLAYBACK APPARATUS, PLAYBACK METHOD AND COMPUTER-READABLE MEDIUM

(75) Inventor: Chang-Hung Lee, Yunlin County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BENQ CORPORATION, Taoyuan Shien (TW)

(21) Appl. No.: 11/734,286

(22) Filed: Apr. 12, 2007

(30) Foreign Application Priority Data
Apr. 21, 2006 (TW) 95114390

(51) Int. Cl. G10L 21/00

(52) U.S. Cl. 704/201

(57) ABSTRACT

A playback apparatus, a playback method and a computer-readable medium are provided. The playback method includes the following steps. Firstly, real-time information including voice real-time information is received. Next, whether the real-time information is a first kind or a second kind is determined according to the voice sample and the speech characteristics of the voice real-time information. Lastly, when the real-time information is changed to the second kind from the first kind or is changed to the first kind from the second kind, a mark is generated correspondingly.

This application claims the benefit of Taiwan application Serial No. 95114390, filed Apr. 21, 2006, the subject matter of which is incorporated herein by reference.

### BACKGROUND OF THE INVENTION

1. Field of the Invention

The invention relates in general to a playback apparatus, a playback method and a computer-readable medium thereof, and more particularly to a playback apparatus, a playback method and a computer-readable medium thereof capable of locating the beginning and the end of advertisement by voice recognition, such that advertisement is automatically skipped during the recording of a program.

2. Description of the Related Art

Playback apparatus has gradually become an essential item of electronic products to modern people. As the playback apparatus is equipped with program recording function, the user is able to record favorite TV programs such as movies, news, basket ball or base ball games.

However, a conventional playback apparatus would include the undesired advertisements in the recording of a program. Therefore, how to enable the playback apparatus to automatically skip the advertisement part during the recording of a program has become a focus to the manufacturers.

### SUMMARY OF THE INVENTION

The invention is directed to a playback apparatus, a playback method and a computer-readable medium thereof capable of locating the beginning and the end of advertisement by voice recognition, such that advertisement is automatically skipped during the recording of a program.

According to a first aspect of the present invention, a playback apparatus is provided. The playback apparatus includes a buffer, an information-receiving unit, a voice recognition unit and a playback module. The information-receiving unit is for receiving real-time information including voice real-time information. The voice recognition unit is for determining whether the real-time information is a first kind or a second kind according to a voice sample and the speech characteristics of the voice real-time information. The playback module is for recording the real-time information onto the storage medium. When the real-time information is changed to the second kind from the first kind or is changed to the first kind from the second kind, the playback apparatus generates a mark correspondingly to determine the beginning and the end of advertisement of the real-time information according to the mark.

According to a second aspect of the present invention, a playback method is provided. The playback method includes the following steps. Firstly, real-time information including voice real-time information is received. Next, whether the real-time information is a first kind or a second kind is determined according to a voice sample and the speech characteristics of the voice real-time information. Lastly, when the real-time information is changed to the second kind from the first kind or is changed to the first kind from the second kind, a mark is generated correspondingly to determine the beginning and the end of advertisement of the real-time information.

According to a third aspect of the present invention, a computer-readable medium is provided. The computer-readable medium includes a plurality of computer-executable instructions for performing a playback method. The playback method includes the following steps. Firstly, real-time information including voice real-time information is received. Next, whether the real-time information is a first kind or a second kind is determined according to a voice sample and the speech characteristics of the voice real-time information. Lastly, when the real-time information is changed to the second kind from the first kind or is changed to the first kind from the second kind, a mark is generated correspondingly to determine the beginning and the end of advertisement of the real-time information.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a playback apparatus according to a preferred embodiment of the invention,

FIG. 2 is a perspective showing program contents and advertisement contents; and

FIG. 3 is a flowchart of a playback method according to a preferred embodiment of the invention.

### DETAILED DESCRIPTION OF THE INVENTION

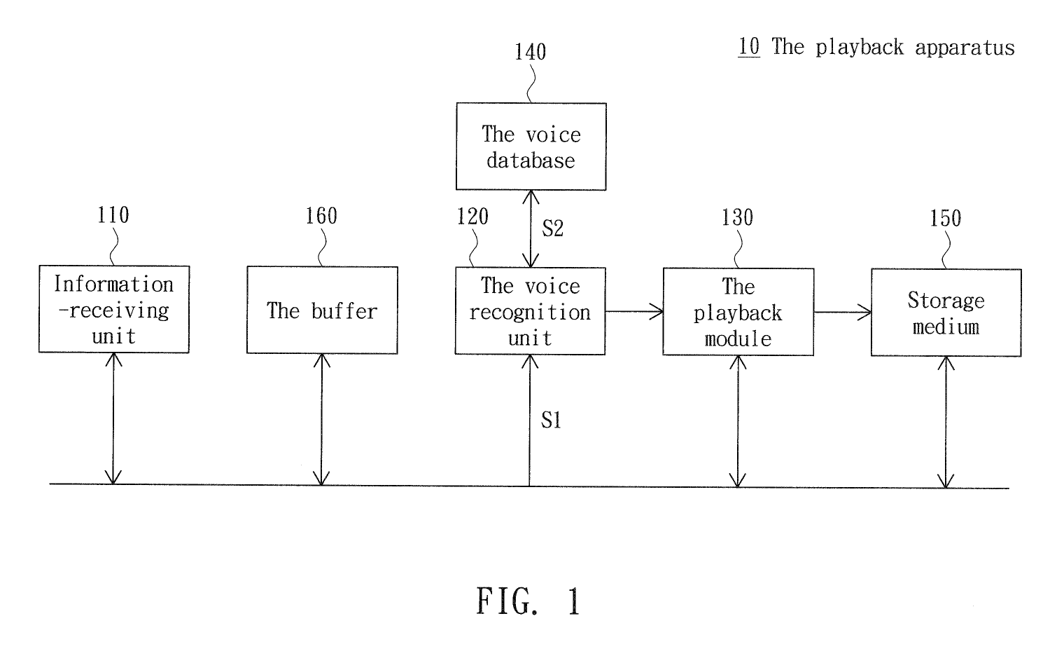

Referring to FIG. 1, a block diagram of a playback apparatus according to a preferred embodiment of the invention is shown. The playback apparatus 10, such as a digital video record (DVR) for example, includes an information-receiving unit 110, a voice recognition unit 120, a playback module 130, a voice database 140 and a buffer 160. The information-receiving unit 110 is for receiving real-time information. Examples of the real-time information include the real-time information from cabled or wireless television broadcast, analog or digital television broadcast, and digital or analog video recorder. The real-time information includes voice real-time information S1. The buffer 160 is for temporarily storing the real-time information. In correspondence to the variety of the above real-time information, the information-receiving unit 110 has a large variety including TV tuner card, video capture card, digital TV receiver, and so on.

The voice database 140 stores a voice sample S2, and can be selectively disposed in the playback apparatus 10 or at a remote end. When the voice database 140 is disposed at the remote end, the playback apparatus 10 is connected to the Internet to receive the voice sample S2. When the voice database 140 is selectively disposed in the playback apparatus 10, the playback apparatus 10 is connected to the Internet to update the voice database 140. The user can create voice sample S2 of the voice database 140 according to the real-time information.

Examples of the voice recognition unit 120 include a voice recognition chip. The voice recognition unit 120 determines whether the real-time information is a first kind or a second kind according to the speech characteristics of the voice sample S2 and the voice real-time information S1. The first kind includes program contents, while the second kind includes advertisement contents. The speech characteristics of the voice real-time information S1 include cadence, pitch, inflection, speed, and so on. If the speech characteristics of the voice real-time information S1 substantially correspond to the voice sample S2, the real-time information is determined as program contents. To the opposite, if the speech characteristics of the voice real-time information S1 do not correspond to the voice sample S2, the real-time information is determined as advertisement contents.

For example, when a presenter's voice appears in the real-time information contains, the voice recognition unit 120 determines the present real-time information as the first kind. To the opposite, when a non-presenter's voice appears in the real-time information, the voice recognition unit 120 determines the present real-time information as the second kind. When the real-time information is changed to the second kind from the first kind or is changed to the first kind from the second kind, the playback apparatus 10 generates a mark correspondingly to determine the beginning and the end of the advertisement of the real-time information.

The mark is exemplified by a first flag and a second flag. When the real-time information is changed to the second kind from the first kind, the playback apparatus 10 correspondingly generates a first flag; when the real-time information is changed to the first kind from the second kind, the playback apparatus 10 correspondingly generates a second flag. The first flag automatically corresponds to the beginning of the second kind real-time information, and the second flag automatically corresponds to the end of the second kind real-time information.

The playback module 130 records the first kind real-time information onto the storage medium 150 according to the first flag and the second flag. Examples of the storage medium 150 include hard disk driver (HDD) and digital video disc (DVD). As the storage medium 150 stores only the first kind real-time information, the user can view a complete program played continuously without being interrupted by advertisements.

Besides, the playback module 130 is also able to continuously play the first kind real-time information according to the first flag and the second flag As the playback apparatus 10 respectively generates a first flag and a second flag in correspondence to the beginning and the end of an advertisement, the playback module 130 is able to continuously play an advertisement-free program according to the first flag and the second flag.

Or, when the user may press the fast key of the remote controller, the playback module 130 will automatically skip the advertisement, and play the next program according to the first flag and the second flag.

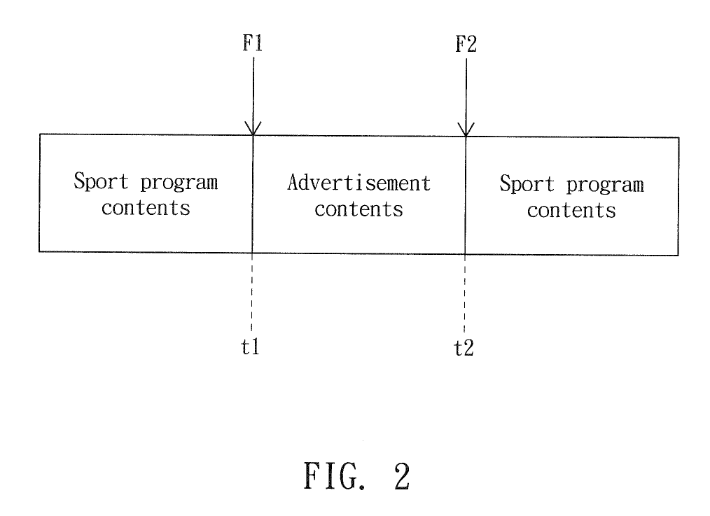

Referring to FIG. 2, a perspective showing program contents and advertisement contents is shown. For example, when recording a football game by the playback apparatus 10, as the presenter employs explains and comments the game verbally, the voice recognition unit 120 can differentiate the program contents and the advertisement contents of the real-time information according to the speech characteristics of the presenter.

For example, when at time t1, the real-time information is changed to advertisement contents from sport program contents. As the speech characteristics of the presenter are different from the voice sample S2, the present moment is the beginning of advertisement, and the playback apparatus 10 generates a first flag F1 correspondingly.

After that, when at time t2, the real-time information is changed to sport program contents from advertisement contents. As the speech characteristics of the presenter correspond to the voice sample S2, the present moment is the end of advertisement, and the playback apparatus 10 generates a second flag F2 correspondingly.

Thus, the playback module 130 can play or record the sport program contents continuously according to the first flag F1 and the second flag F2 without being interrupted by advertisements, such that the pleasure of viewing a game will not be jeopardized by advertisements.

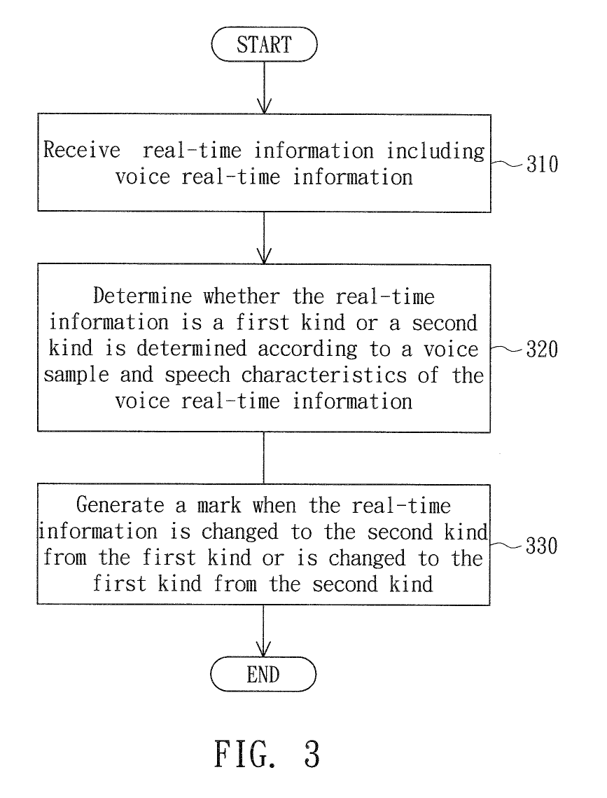

Referring to FIG. 3, a flowchart of a playback method according to a preferred embodiment of the invention is shown. The playback method is used in the playback apparatus 10 mentioned above. The playback method includes the following steps. Firstly, the method begins at step 310, real-time information including voice real-time information S1 is received by an information-receiving unit 110. Next, the method proceeds to step 320, whether the real-time information is a first kind or a second kind is determined according to a voice sample S2 and speech characteristics of the voice real-time information S1. Lastly, the method proceeds to step 330, when the real-time information is changed to the second kind from the first kind or is changed to the first kind from the second kind, the playback apparatus 10 generates a mark correspondingly to determine the beginning and the end of the advertisement of the real-time information.

Moreover, as a plurality of computer-executable instructions are stored in a computer-readable medium, a playback apparatus is able to perform the above playback method as long as the playback apparatus is equipped with the computer-readable medium.

According to the playback apparatus and method disclosed in the above embodiments of the invention, the beginning and the end of an advertisement are located by voice recognition, and a mark is respectively generated at the beginning and the end of the advertisement, such that the playback apparatus is able to play an advertisement-free program according to the mark automatically.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A playback apparatus, comprising:
an information-receiving unit for receiving real-time information, wherein the real-time information comprises voice real-time information;
a buffer for temporarily storing the real-time information;
a voice recognition unit for determining whether the real-time information is a first kind or a second kind according to a voice sample and the speech characteristics of the voice real-time information; and
a playback module for recording the real-time information onto a storage medium;
wherein, when the real-time information is changed to the second kind from the first kind or is changed to the first kind from the second kind, the playback apparatus generates a mark correspondingly.

2. The playback apparatus according to claim 1, wherein the mark comprises a first flag and a second flag, the playback apparatus generates the first flag when the real-time information is changed to the second kind from the first kind and generates the second flag when the real-time information is changed to the first kind from the second kind.

3. The playback apparatus according to claim 2, wherein the first kind is a presenter's voice, the second kind is a non-presenter's voice.

4. The playback apparatus according to claim 2, wherein the first flag automatically corresponds to the beginning of the second kind real-time information, and the second flag automatically corresponds to the end of the second kind real-time information.

5. The playback apparatus, according to claim 4, wherein the playback module continuously plays the first kind real-time information according to the first flag and the second flag.

6. The playback apparatus according to claim 4, wherein the playback module records the first kind real-time information onto the storage medium according to the first flag and the second flag.

7. The playback apparatus according to claim 1, wherein the voice sample is provided by a voice database.

8. The playback apparatus according to claim 7, wherein the voice database is disposed at a remote end, and the playback apparatus is connected to the Internet to receive the voice sample.

9. The playback apparatus according to claim 7, wherein the voice database is disposed in the playback apparatus connected to the Internet to update the voice database.

10. The playback apparatus according to claim 7, wherein the voice database is disposed in the playback apparatus, and the user creates the voice sample according to the real-time information.

11. A playback method, comprising:
receiving real-time information, wherein the real-time information comprises voice real-time information;
determining whether the real-time information is a first kind or a second kind according to a voice sample and the speech characteristics of the voice real-time information; and
when the real-time information is changed to the second kind from the first kind or is changed to the first kind from the second kind, a mark is generated correspondingly.

12. The playback method according to claim 11, wherein the step of generating the mark comprises:
generating a first flag correspondingly when the real-time information is changed to a second kind from a first kind, wherein the first flag automatically corresponds to the beginning of the second kind real-time information; and
generating a second flag correspondingly when the real-time information is changed to the first kind from the second kind, wherein the second flag automatically corresponds to the end of the second kind real-time information.

13. The playback method according to claim 12, wherein the step of generating the mark comprises:
generating a first flag correspondingly when the real-time information is changed to a non-presenter's voice from the presenter's voice; and
generating a second flag correspondingly when the real-time information is changed to the presenter's voice from the non-presenter's voice.

14. The playback method according to claim 12, further comprising:
playing the first kind real-time information continuously according to the first flag and the second flag.

15. The playback method according to claim 12, further comprising:
recording the first kind real-time information onto a storage medium according to the first flag and the second flag.

16. The playback method according to claim 12, further comprising:
outputting the voice sample form a voice database.

17. A computer-readable medium comprising a plurality of computer-executable instructions for performing a playback method, the playback method comprising:
receiving real-time information, wherein the real-time information comprises voice real-time information;
determining whether the real-time information is a first kind or a second kind according to a voice sample and the speech characteristics of the voice real-time information; and
generating a mark correspondingly when the real-time information is changed to the second kind from the first kind or is changed to the first kind from the second kind.

18. The computer-readable medium according to claim 17, wherein the computer-readable medium is disposed in a digital video record (DVR).

19. The computer-readable medium according to claim 17, wherein the mark comprises a first flag and a second flag, and the playback apparatus generates the first flag when the real-time information is changed to the second kind from the first kind and generates the second flag when the real-time information is changed to the first kind from the second kind.

20. The computer-readable medium according to claim 17, wherein the first kind is a presenter's voice, and the second kind is a non-presenter's voice.
